(19) United States
(12) Patent Application Publication
(10) Pub. No.: US 2014/0071324 A1
(43) Pub. Date: Mar. 13, 2014

(54) IMAGING APPARATUS

(71) Applicant: Panasonic Corporation, Osaka (JP)

(72) Inventors: HIRONARI TOKUNAGA, Osaka (JP); MITSUO ABE, Osaka (JP)

(73) Assignee: Panasonic Corporation, Osaka (JP)

(21) Appl. No.: 14/022,344

(22) Filed: Sep. 10, 2013

(30) Foreign Application Priority Data
Sep. 12, 2012 (JP) 2012-200097

(51) Int. Cl. H04N 5/232

(52) U.S. Cl. CPC H04N 5/23293
USPC 348/333.02

(57) ABSTRACT

An imaging apparatus includes an image processor configured to apply image processing on image data to generate image data for recording, a display unit configured to display an image based on image data generated by an imaging unit, and a controller configured to control displaying of image on the display unit. The controller controls the image processor to apply image processing on the image data generated by the imaging unit based on a shooting instruction from a user, and causes an image based on the image data captured by the imaging unit and information indicating progress of the image processing to be displayed on the display unit in parallel with the image processing, and causes an image based on the image data for recording generated by the image processing to be displayed on the display unit after completion of the image processing.

### BACKGROUND

1. Technical Field

The present disclosure relates to an imaging apparatus capable of displaying a through image on a display unit during a standby state.

2. Related Art

The imaging apparatus such as a digital camera is capable of displaying an image (through image) on a display unit such as a liquid crystal display (LCD) monitor based on image data captured by an imaging device in real time. A user can take an image by determining a composition and the like by viewing the through image.

Some apparatuses are configured to temporarily display an image which is captured and subjected to image processing immediately after an image capturing operation, so that the user can confirm the captured image (this type of display is referred to as “review display”). Once the review display starts, the user cannot shoot the next image until display of the through image is restarted After completion of the review display.

If the imaging apparatus can quickly restart display of the through image after a shooting operation, it can reduce an interval from when the user takes the previous image until the user is enabled to take the next image.

For example, Japanese patent application publication JP2005-159538 A discloses a configuration that achieves a shorter interval by performing a compression operation on image data of a still image and an exposure operation of the next through image in parallel.

However, in the case where displaying of the through image on the display unit is performed in parallel with the image processing after the user taking the image, the review display is started as soon as the image processing is completed. That control makes the display of the through image suddenly finish and the review display suddenly start, which may confuse the user.

### SUMMARY

The present disclosure has a purpose to provide an imaging apparatus capable of presenting a user-friendly image display.

An imaging apparatus according to the present disclosure includes an imaging unit configured to capture a subject image to generate image data, an operation unit configured to receive an operation of shooting instruction from a user, an image processor configured to apply image processing on the image data to generate image data for recording, a display unit configured to display an image based on the image data generated by the imaging unit, and a controller configured to control displaying of image on the display unit. The controller controls the image processor to apply the image processing on the image data generated by the imaging unit based on the operation of shooting instruction received by the operation unit. In parallel with the image processing, the controller causes an image based on the image data captured by the imaging unit and information indicating progress situation of the image processing to be displayed on the display unit. Then after completion of the image processing, the controller causes an image based on the image data for recording generated by the image processing to be displayed on the display unit.

According to the present disclosure, an imaging apparatus can be provided, which can present a user-friendly image display.

### BRIEF DESCRIPTION OF DRAWINGS

FIG. 1 is a front view of a digital camera according to an embodiment;

FIG. 2 is a rear view of the digital camera according to the embodiment;

FIG. 3 is a block diagram of the digital camera according to the embodiment;

FIG. 4 is a flow chart describing a flow of processes performed by the digital camera according to the embodiment in the shooting mode;

FIG. 5A is a diagram illustrating an example of a display presented during a synthesizing process by the digital camera according to the embodiment;

FIG. 5B is a diagram illustrating an example of review display of the digital camera according to the embodiment;

FIG. 6 is a timing chart showing an example of operation timing of the digital camera according to the embodiment;

FIG. 7 is a diagram describing relationship between captured images and display images during the through image display, the progress bar display, and the review image display;

FIG. 8 is a timing chart showing an example of operation timing of a digital camera according to another embodiment;

FIG. 9 is a timing chart showing another example of operation timing of a digital camera according to another embodiment; and

FIG. 10 is a diagram illustrating another example of information indicating progress situation which is displayed with a through image.

### DETAILED DESCRIPTION OF PREFERRED EMBODIMENTS

Embodiments will be described below in detail with reference to the drawings as required. However, unnecessarily detailed description may be omitted. For example, detailed description of already known matters and redundant description of substantially the same configuration may be omitted. All of such omissions are for avoiding unnecessary redundancy in the following description to facilitate understanding of those skilled in the art.

The inventor(s) provide the accompanying drawings and the following description for those skilled in the art to fully understand the present disclosure and does not intend to limit the subject described in the claims by the accompanying drawings and the following description.

The same or similar reference signs are provided to the same or similar parts in the drawings below. However, the drawings are schematic and ratios of dimensions, and the like would be different from those actual. Therefore, specific dimensions and the like should be determined with reference to the following description. Further, it is needless to say that relationship or ratios of the dimensions may partially differ from each other also among the drawings.

### 1. First Embodiment

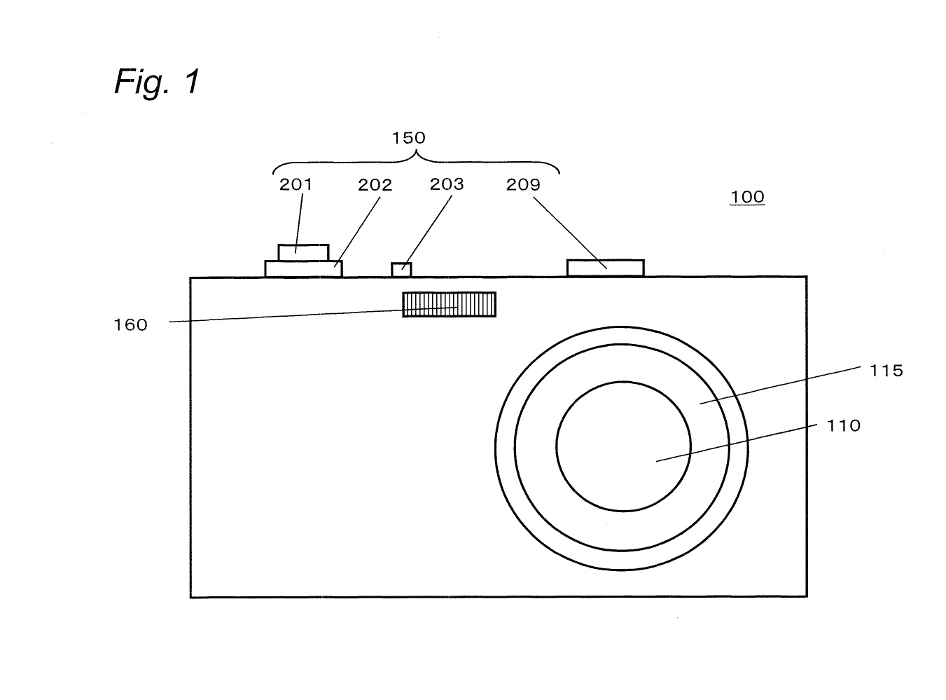

A digital camera (an example of the imaging apparatus) according to the embodiment will be described with reference to FIGS. 1 to 10. The digital camera is an imaging device capable of capturing a moving image and a still image.

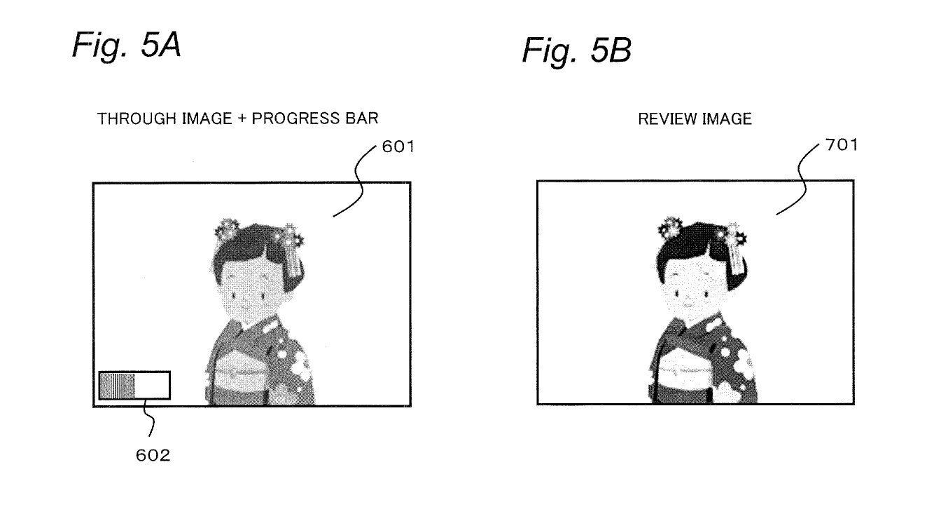

The digital camera performs a synthesizing process on image data generated by a CCD image sensor based on a shooting instruction from a user. In parallel with the synthesizing process, the digital camera causes a through image 601 based on the image data captured by the CCD image sensor and information indicating progress situation of the synthesizing process (for example, a progress bar which changes its length according to the progress situation) 602 to be displayed on a liquid crystal display (LCD) monitor as illustrated in FIG. 5. Then, after completion of the image processing, the digital camera causes a review image based on the image data for recording generated by the synthesizing process to be displayed on the LCD monitor.

As described above, the digital camera allows the user to know or predict end timing of the synthesizing process and start timing of the review display, by displaying a progress bar which indicates progress situation of the synthesizing process and is superimposed on the through image. As a result, the digital camera can provide a user-friendly interface. Such a digital camera will be described in detail below.

### 1-1. Configuration of the Digital Camera

FIG. 1 is a front view of a digital camera according to the embodiment. As illustrated in FIG. 1, the digital camera 100 has a lens barrel 115 which contains an optical system 110 and a flash 160 in the front. The digital camera 100 has an operation unit 150 including a still image release button 201, a zoom lever 202, a power button 203, and a scene switching dial 209 on the top surface.

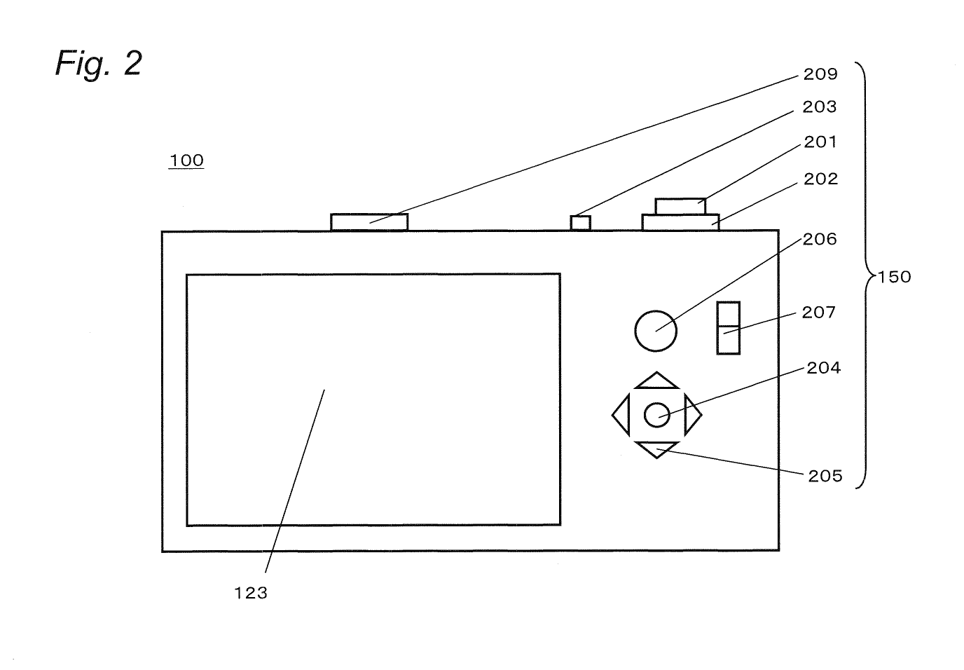

FIG. 2 is a rear view of the digital camera according to the embodiment. As illustrated in FIG. 2, the digital camera 100 has the operation unit 150 including a LCD monitor 123, a center button 204, directional buttons 205, a moving image release button 206, and a mode switch 207 on the rear.

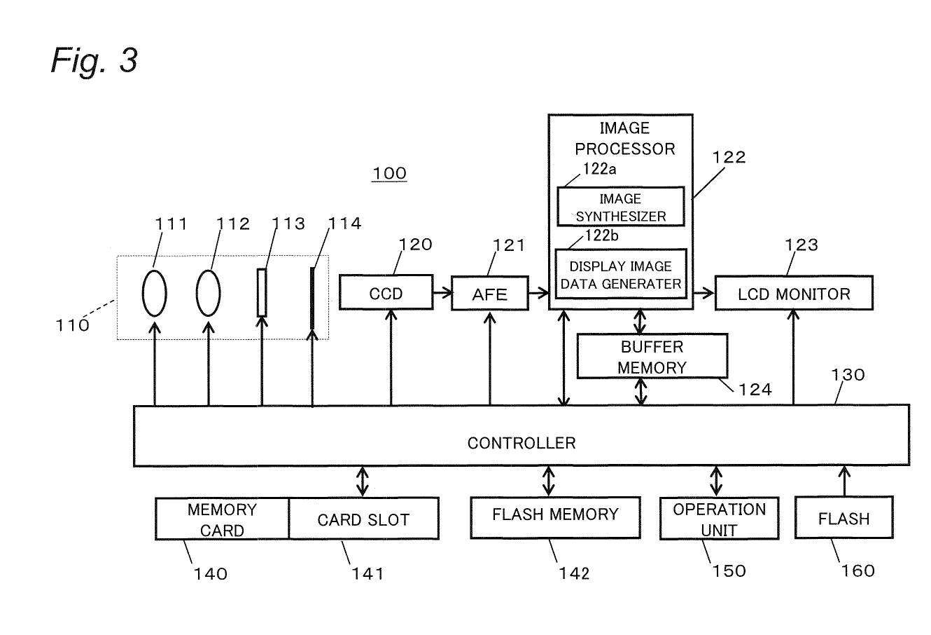

FIG. 3 is a block diagram of the digital camera according to the embodiment. As illustrated in FIG. 3, the digital camera 100 has an optical system 110, a CCD image sensor 120, an AFE (Analog Front End) 121, an image processor 122, a buffer memory 124, a LCD monitor 123, a controller 130, a card slot 141, a memory card 140, a flash memory 142, an operation unit 150, and a flash 160.

The optical system 110 forms a subject image. The optical system 110 has a focus lens ill, a zoom lens 112, a diaphragm 113, and a shutter 114. As another embodiment, the optical system 110 may include an Optical Image Stabilizer (OIS) lens for optically correcting camera shake. The optical system 110 may include any number of lenses or any number of lens groups.

The focus lens 111 is a lens for adjusting a focus state for a subject. The zoom lens 112 is a lens for adjusting an angle of view of the subject. The diaphragm 113 adjusts the amount of light incident on the CCD image sensor 120. The shutter 114 adjusts the exposure time of light incident on the CCD image sensor 120. The focus lens 111, the zoom lens 112, the diaphragm 113, and the shutter 114 are driven by driving units such as a DC motor and a stepping motor according to control signals generated by the controller 130.

The CCD image sensor 120 is an imaging device which captures a subject image formed by the optical system 110. The CCD image sensor 120 generates image data of each of frames including the subject images.

The AFE (Analog Front End) 121 performs respective types of processing on the image data generated by the CCD image sensor 120. Specifically, the AFE 121 performs processing such as noise suppression by correlated double sampling, amplification to an input range of an A/D converter by an analog gain controller, and A/D conversion by the A/D convertor.

The image processor 122 performs predetermined image processing on the image data which has been subjected to several types of processing by the AFE 121. The image processor 122 performs processing including smear correction, white balance correction, gamma correction, a YC conversion process, an electronic zoom process, a compression process, a reduction process, and an expansion process on the image data. The image processor 122 generates image data for displaying (through image) and image data for recording by performing such processing on the image data. In the embodiment, the image processor 122 is a microcomputer which executes a program. However, the image processor 122 may be a hardwired electronic circuit in other embodiments. The image processor 122 may also be integrated with the controller 130 and the like.

The image processor 122 performs processing including processing by an image synthesizer 122a and processing by a display image data generator 122b based on an instruction from the controller 130. When it is required to synthesize a plurality of image data, the image processor 122 performs processing by the image synthesizer 122a based on an instruction from the controller 130. Details of the processing by the image synthesizer 122a will be described later.

The controller 130 performs overall control for operations of the entire digital camera 100. The controller 130 includes a ROM and a CPU. The ROM stores programs related to file control, autofocus control (AF control), automatic exposure control (AE control), and emission control for the flash 160 as well as programs for performing overall control for the operations of the entire digital camera 100.

The controller 130 records the image data which has been subjected to the respective types of processing by the image processor 122 in a memory card 140 or the flash memory 142 (hereinafter, referred to as “the memory card 140 and the like”) as still image data or moving image data. Although the controller 130 is a microcomputer which executes a program in this embodiment, it may be a hardwired electronic circuit in other embodiments. The controller 130 may also be integrated with the image processor 122 and the like.

The LCD monitor 123 displays the images such as the through image and a recorded image. The through image and the recorded image are generated by the image processor 122. The through image is a series of images which are serially generated at certain time intervals when the digital camera 100 is set to the shooting mode. A series of image data corresponding to the series of images is generated by the CCD image sensor 120 at certain time intervals. With the through image displayed on the LCD monitor 123 for reference, the user can take an image by confirming the composition of the subject.

The recorded image is an image which can be obtained by decoding (decompression) the still image data or the moving image data recorded in a recording medium such as the memory card 140 and the like. The recorded image is displayed on the LCD monitor 123 when the digital camera 100 is set to the playback mode. In the case where the digital camera 100 is set to the shooting mode and a new still image data or a new moving image data is recorded by the shooting operation, the image recorded by the shooting operation is temporarily displayed on the LCD monitor 123 as the review display immediately after the completion of the shooting operation (hereinafter, the image displayed as the review display will be referred to as “review image”). Any display which can display an image such as an organic electroluminescence display may be used in place of the LCD monitor 123.

The buffer memory 124 is a volatile storage medium that functions as a work memory for the image processor 122 and the controller 130. In this embodiment, the buffer memory 124 is a DRAM.

The flash memory 142 is an internal memory of the digital camera 100. The flash memory 142 is a non-volatile recording medium. The flash memory 142 has a customized item registration area and a current value holding area.

The card slot 141 accommodates the removable memory card 140. The card slot 141 is electrically and mechanically connected to the memory card 140.

The memory card 140 is an external memory of the digital camera 100. The memory card 140 is a non-volatile recording medium.

The operation unit 150 is an interface for users to operate the digital camera 100. The operation unit 150 collectively refers to operation buttons and an operation dial provided on the exterior of the digital camera 100. The operation unit 150 includes the still image release button 201, the moving image release button 206, the zoom lever 202, the power button 203, the center button 204, the directional buttons 205, the mode switch 207, and the scene switching dial 209. When the operation unit 150 receives an operation by the user, it sends a signal corresponding to the user's operation to the controller 130.

The still image release button 201 is a push switch for instructing the timing of still image recording. The moving image release button 206 is a push switch for instructing the start/finish timing of moving image recording. The controller 130 controls the image processor 122 and the like to generate still image data or moving image data at timing of the pressing action on the release button 201 or 206, and stores the generated data in the memory card 140 or the like.

The zoom lever 202 is a lever for adjusting the angle of view between the wide-angle end and telephoto end. The controller 130 drives the zoom lens 112 according to the operation by the user on the zoom lever 202.

The power button 203 is a slide switch for switching ON/OFF of the power supply for the respective components of the digital camera 100.

The center button 204 and directional buttons 205 are push buttons. By operating the center button 204 and the directional buttons 205, the user can display various setting screens (including a setting menu screen and a quick setting menu screen which are not shown) on the LCD monitor 123. In these setting screens, the user can set values of the setup items related to various shooting conditions and playback conditions.

The mode switch 207 is a slide switch for switching the digital camera 100 to the shooting mode or the playback mode.

The scene switching dial 209 is a dial for switching scene modes. The scene mode collectively refers to modes to be set according to the situations of taking an image. The factors which influence the situations of taking an image include the respective subjects and the shooting environment. Switching of the scene switching dial 209 allows any one of the scene modes to be set.

The scene modes include, for example, landscape mode, portrait mode, night view mode, and backlight mode. For example, the portrait mode is a mode suitable for the case where it is desired to take an image of a person with a natural skin tone. The backlight mode is a mode suitable for the case where an image is taken in the environment having a big difference in brightness. The backlight mode is a mode for performing a continuous shooting synthesizing process. The continuous shooting synthesizing process is a process to capture a plurality of images with different settings and synthesize data for the plurality of captured images into one piece of image data. Generally, the time required for obtaining image data by the continuous shooting synthesizing process is longer than the time required for obtaining one image data by one image-taking operation. The continuous shooting synthesizing process is an example of predetermined image processing.

### 1-2. Operation in Shooting Mode

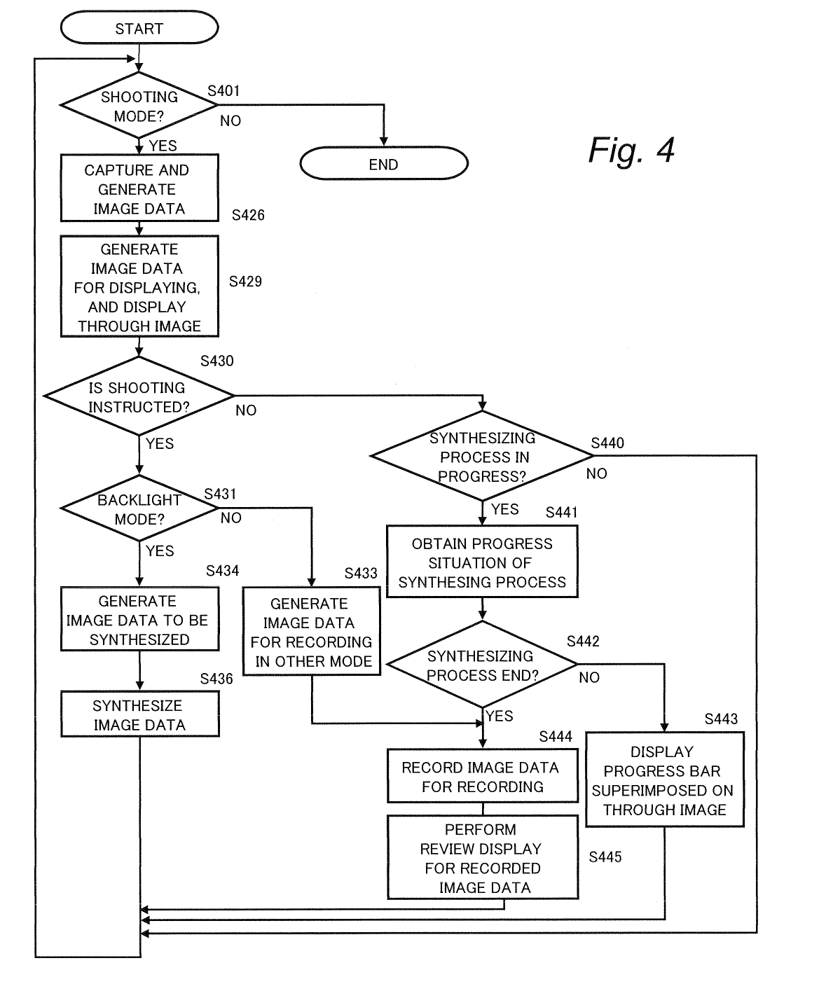

FIG. 4 is a flow chart describing a flow of processes performed by the digital camera according to the embodiment in the shooting mode. With reference to FIG. 4, the operation in the shooting mode will be described. In the following description, the case of the operation for shooting a still image is described.

When the user operates the power button 203 to turn on the digital camera 100, the controller 130 refers to settings of the mode switch 207 (S401). Specifically, the controller 130 determines whether the mode switch 207 is set to a shooting mode or a playback mode. When the mode switch 207 is set to the playback mode (No in S401), the controller 130 finishes the process related to the shooting mode.

When the mode switch 207 is set to the shooting mode (Yes in S401), the controller 130 enters a standby state in the shooting mode to be ready for performing the shooting operation based on the scene mode which is set in accordance with a shooting instruction from a user.

Here, the scene mode will be described. The scene mode is selected from among a plurality of scene modes preset in the digital camera 100. For example, when the user operates the operation unit 150 to select any one of the scene modes, the selected scene mode is recognized by the controller 130. More specifically, any one of the scene modes such as a landscape mode, a portrait mode, a night view mode, and a backlight mode is selected by the user and is recognized by the controller 130.

The controller 130 recognizes the image data (sensor image data) generated by the CCD image sensor 120 (S426). Subsequently, the image processor 122 generates image data for displaying by performing a process according to the scene mode set by the controller 130 on the image data (S429). Based on the image data for displaying, a through image is displayed on the LCD monitor 123 (S429).

The controller 130 detects a status of pressing the still image release button 201 while displaying the through image (S430). When the controller 130 detects that the still image release button 201 is pressed (Yes in S430), it refers to the scene mode set by the operation unit 150 (S431). It is noted that in the following description, a case where the scene mode is set to the backlight mode will be described in particular, but when the scene mode is set to the other modes, processes corresponding to the respective scene modes will be performed instead.

When the scene mode is set to the backlight mode (Yes in S431), the controller 130 performs a process of creating image data for recording in the backlight mode (S434). Specifically, the controller 130 creates the image data for recording in the backlight mode by the continuous shooting synthesizing process. More specifically, the controller 130 generates one image data by capturing three images of different exposures and synthesizing the images.

Here, the continuous shooting synthesizing process in the backlight mode will be described. In the case where the continuous shooting synthesizing process is performed in the environment which has a big difference in brightness such as the backlight environment, the more the number of image data of different exposures are captured, the more natural the color tone can be realized in the generated image ranging from the dark part to the bright part. In the following description of this embodiment, the three images which are captured with different exposures are synthesized.

In the first place, in order to obtain a first image, the controller 130 issues a command to the optical system 110 to drive the optical system 110 to achieve underexposure. By shooting an image with the above setting, it is possible to obtain image data in which a relatively bright area is more properly exposed. Since the image data shot as such is shot with underexposure, the image data is darker than the second and third image data as a whole. The image processor 122 performs image processing, which is suitable for a relatively bright area in image data, on the image data output from the AFE 121. Then, the controller 130 stores the image data in the buffer memory 124.

Next, in order to obtain a second image, the controller 130 issues a command to the optical system 110 to drive the optical system 110 to achieve a medium exposure between the underexposure and overexposure. By shooting an image with the above setting, it is possible to obtain image data in which an area of medium brightness is more properly exposed. The image processor 122 performs image processing, which is suitable for medium brightness, on the image data output from the AFE 121. Then, the controller 130 stores the image data in the buffer memory 124.

Next, in order to obtain a third image, the controller 130 issues a command to the optical system 110 to drive the optical system 110 to achieve overexposure. By shooting an image with the above setting, it is possible to obtain image data in which a relatively dark area is more properly exposed. Since the image data shot as such is shot with overexposure, it is brighter than the first and second image data as a whole. The image processor 122 performs image processing, which is suitable for relatively dark area of image data, on the image data output from the AFE 121. Then, the controller 130 stores the image data in the buffer memory 124.

In the above described manner, three pieces of image data continuously shot with the different exposures are then subjected to a synthesizing process.

For that purpose, the controller 130 instructs the image synthesizer 122a to perform a process of synthesizing the three pieces of image data stored in the buffer memory 124 to create the image data for recording (S436). In response to the instruction, the image synthesizer 122a starts the process of synthesizing the three pieces of image data. The synthesizing process is performed by the image synthesizer 122a in parallel with the other processes performed by the controller 130 described in the flow chart of FIG. 4. The controller 130 periodically communicates with the image synthesizer 122a to recognize the progress of the synthesizing process (Note: This operation is described later).

Then, the controller 130 performs again the process of referring to the mode (shooting mode, playback mode) set by the mode switch 207 (S401). When the shooting mode is maintained, the controller 130 identifies the image data generated by the CCD image sensor 120 (S426) and creates the image data for displaying so that the through image is displayed on the LCD monitor 123, as described above (S429).

When not detecting that the still image release button 201 is pressed by the user while the through image is displayed (No in S430), the controller 130 determines whether the synthesizing process is in progress by the image synthesizer 122a (S440). Specifically, when the controller 130 has instructed the image synthesizer 122a to perform the synthesizing process in step S436 but it has not been notified of the end of the synthesizing process, the controller 130 determines that the synthesizing process is in progress by the image synthesizer 122a.

When determining that the synthesizing process is not in progress by the image synthesizer 122a (No in S440), the controller 130 performs again the process of referring to the mode (shooting mode, playback mode) set by the mode switch 207 (S401).

On the other hand, when determining that the synthesizing process is in progress by the image synthesizer 122a (Yes in S440), the controller 130 obtains from the image synthesizer 122a the progress situation of the synthesizing process which has been previously instructed to the image synthesizer 122a to perform (S441). Based on the obtained progress situation, the controller 130 determines whether the synthesizing process has finished (S442).

When determining that the synthesizing process has not finished yet based on the progress situation obtained from the image synthesizer 122a (No in S442), the controller 130 superimposes a progress bar on the through image to display it on the LCD monitor 123 as information indicating the progress situation of the synthesizing process (S443).

FIG. 5A is a diagram illustrating an example of display shown during the synthesizing process by the digital camera 100. As illustrated in the figure, a progress bar 602 indicating the progress situation of the synthesizing process is superimposed on a through image 601. By referring to the progress bar 602, the user can predict how much more time it takes to complete the image synthesizing process.

On the other hand, when determining that the synthesizing process has finished (Yes in S442), the controller 130 performs a process of recording the image data for recording generated by the synthesizing process on a recording medium, such as the memory card 140 (S444). Then, the controller 130 finishes displaying the image data for displaying (through image display) and the progress bar, and displays an image (review image) based on the image data for recording on the LCD monitor 123 (review display) (S445).

FIG. 5B is a diagram illustrating an example of review display of the digital camera 100. The controller 130 does not display the through image while displaying a review image 701. After performing the review display for a previously set predetermined time (for example, three seconds), the controller 130 finishes the review display. After the finish of the review display, the controller 130 performs again the process of referring to the mode set by the mode switch 207 (S401).

When the scene mode is set to the mode other than the backlight mode (No in S431), the image processor 122 creates the image data for recording by performing image processing which is suitable for that scene mode (S433). For example, when it is determined that the scene mode is set to the portrait mode, the image processor 122 creates the image data for recording by performing image processing to adjust color of person's skin to a natural skin tone.

When the image data for recording corresponding to the scene mode is created, the controller 130 performs the process of recording the image data for recording on the memory card 140 (S444) and displays the image on the LCD monitor 123 as the review display for a predetermined time (S445). After the finish of the review display, the controller 130 performs again the process of referring to the mode set by the mode switch 207 (S401).

The above described series of processes is repeated until the user changes the mode switch 207 to the playback mode (No in S401) or turns off the digital camera 100. In the case where the image synthesizing process is in progress when the user switches the mode switch 207 to the playback mode (No in S401), the digital camera 100 may transfer to the playback mode when the image synthesizing process finishes. Alternatively, the digital camera 100 may transfer to the playback mode before the finish of the image synthesizing process and start to display the image data subjected to the synthesizing process when the image synthesizing process finishes.

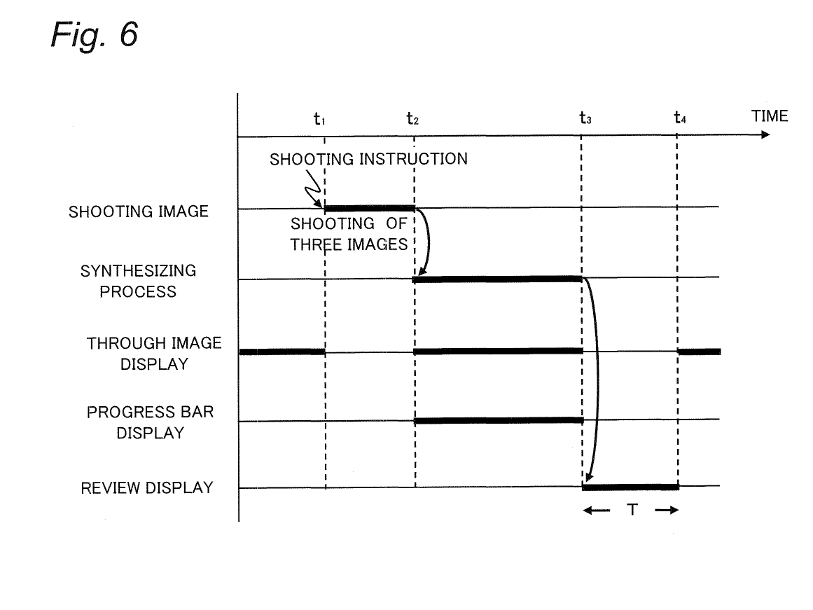

FIG. 6 shows timings of operation for a shooting process, a synthesizing process, through image display, progress bar display, and review image display according to this embodiment, in a case where an image is taken in the backlight mode, as an example.

First, when the controller 130 determines that the mode switch 207 is set to the shooting mode, the controller 130 performs the through image display (S429). Next, when the controller 130 receives an instruction from the user, at time t1, to take an image in the backlight mode (Yes in S431), the controller 130 generates three pieces of image data to be synthesized (S434).

When the generation of the image data to be synthesized completes, at time t2, the image synthesizer 122a starts the synthesizing process according to the instruction from the controller 130 (S436). Almost at the same time, generation of the image data for displaying performed by the display image data generator 122b and the through image display (S429) are restarted, and the digital camera 100 enters the standby state which is ready for receiving the shooting instruction. Also, the controller 130 obtains the progress situation of the synthesizing process performed by the image synthesizer 122a (S441) and displays the progress bar on the through image (S443). That is, the progress bar 602 is displayed with the through image on the LCD monitor 123 (see FIG. 6A) while the image synthesizer 122a is performing the synthesizing process. With such display, the user can confirm the through image in preparation for a upcoming chance to capture a good shot while waiting for the synthesizing process to be completed, and also know estimate of timing at which the synthesizing process completes.

Next, when the synthesizing process finishes at time t3 (Yes in S442), the through image display and the progress bar display finish, and the review display of the image data which has been subjected to the synthesizing process is performed (S445).

Subsequently, when the review image display finishes at time t4, the through image display is restarted (S429) and the digital camera 100 enters the standby state which waits for the next shooting instruction.

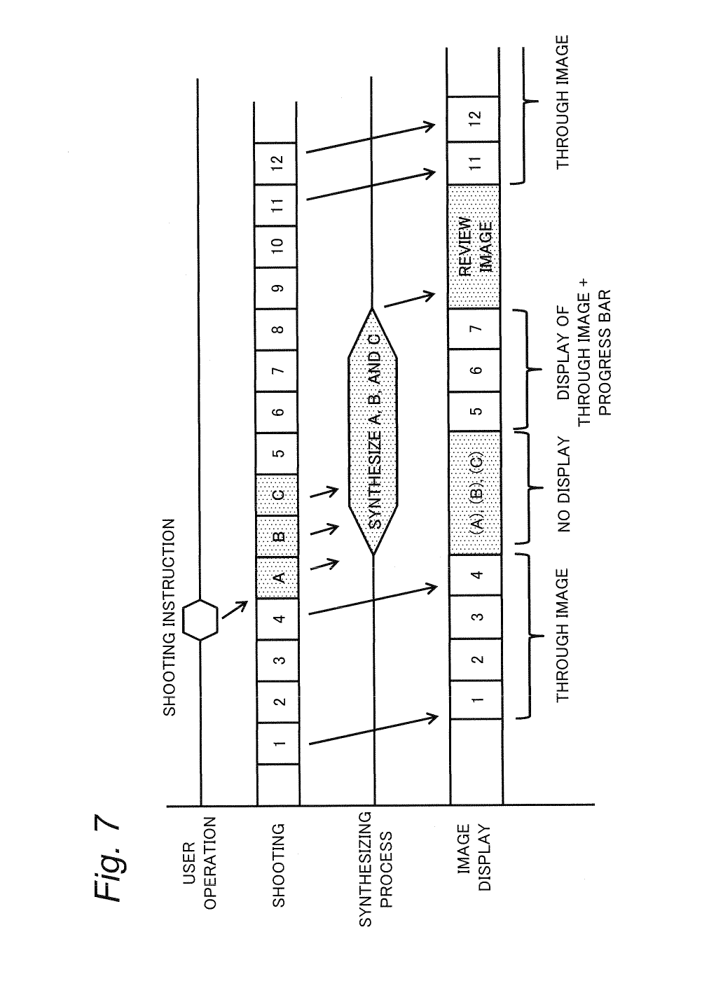

FIG. 7 is a diagram describing correspondence between captured images and display images during the through image display, the progress bar display, and the review image display. As illustrated in FIG. 7, images 1, 2, . . . etc. are captured by the digital camera 100 by predetermined periods (frames). The captured images 1, 2, . . . etc. are displayed on the LCD monitor 123 as the through image. In the case where the user carries out the operation of shooting instruction when the image 4 is captured, images A, B, and C to be synthesized are captured. After the images A, B, and C to be synthesized are captured, images 5, 6, and 7 are captured. The synthesizing process is applied to the images A, B, and C. During the synthesizing process, the through image is displayed for the images A, B, and C, and the progress bar is displayed with the through image for the images 5, 6, and 7. After the synthesizing process of the images A, B, and C finishes, the review image of the synthesized image is displayed for a certain period, and after the review display finishes, a normal through image display is restarted.

### 1-3. Effects and the Like

As described above, the digital camera 100 of the embodiment includes the CCD image sensor 120 for capturing a subject image to generate image data, the operation unit 150 for receiving user's operation of a shooting instruction, the image synthesizer 122a which can generate image data for recording by performing a synthesizing process on image data, the LCD monitor 123 which can display an image based on the image data generated by the CCD image sensor 120, and the controller 130 for controlling image display on the LCD monitor 123. The controller 130 controls the image synthesizer 122a to perform the synthesizing process on the image data generated by the CCD image sensor 120 based on the instruction of the shooting instruction received by the operation unit 150. The controller 130 causes the through image 601 based on the image data captured by the CCD image sensor 120 and the progress bar 602 indicating the progress situation of the synthesizing process performed by the image synthesizer 122a to be displayed on the LCD monitor 123 in parallel with the synthesizing process. After the completion of the synthesizing process, the controller 130 causes the review image 701 based on the image data for recording generated by the synthesizing process to be displayed on the LCD monitor 123.

As a result, the digital camera 100 can prepare for the next shooting while displaying the through image in parallel with the synthesizing process. Further, the digital camera 100 superimposes a progress bar which indicates the progress situation of the synthesizing process on the through image and displays the progress bar, so that the user can know or predict the end timing of the synthesizing process and the start timing of the review display. Therefore, the digital camera can provide a user friendly interface.

### 2. Other Embodiments

As described above, the first embodiment has been described as an example of the technology disclosed in the present application. However, the technology in the present disclosure is not limited to that embodiment and may also be applied to embodiments which are subject to modification, substitution, addition, or omission as required. In addition, the respective constituent elements described in the first embodiment may be combined to make a new embodiment. Then, other embodiments will be exemplified below.

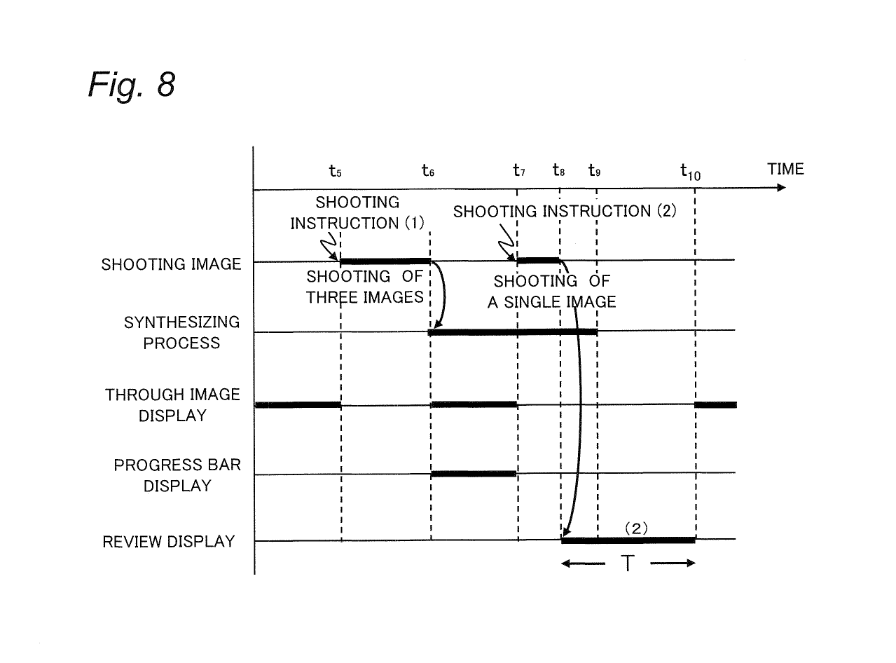

(1) In the control of the above described embodiment, when a new image is shot during the image synthesizing process (before the review display of the image resulting from the continuous shooting synthesizing process) by the review display of only the synthesized image based on the image shot last without displaying the review display of the synthesized image based on images shot earlier. FIG. 8 is a diagram showing timing of the respective processes in time series as in FIG. 6 for the case where continuous shooting is performed in the backlight mode and then the next single-frame shooting is performed during the synthesizing process for the images shot by the continuous shooting. At time t5, the continuous shooting is started in the backlight mode according to the shooting instruction. Then, at time t6, the synthesizing process, the through image display, and the progress bar display are started respectively.

In the case where an instruction of a single-frame shooting is provided by, for example, switching the scene mode at time t7 which is before completion of the synthesizing process, the controller 130 finishes the through image display and the progress bar display when receiving an instruction to perform the next shooting. When the shooting finishes at time t8, the controller 130 starts displaying the review image taken by the single-frame shooting. When the review image display finishes and time t10 is reached, the controller 130 restarts displaying the through image and enters the standby state for shooting an image. At time t9, the synthesizing process of the image resulting from the continuous shooting synthesizing process which has been instructed earlier as such finishes. However, at time t7 before time t9, the controller 130 was instructed to perform the next shooting. Therefore, the controller 130 does not perform the review display of the image resulting from the continuous shooting synthesizing process corresponding to the earlier shooting.

In the above described manner, in the case where the next shooting is further performed before performing the review display of the image data shot earlier, the controller 130 performs the review display of only the last image data photographed by the user. That reduces the wait time for the review display, and extends the display period of the through image, therefore, the convenience of the user is improved.

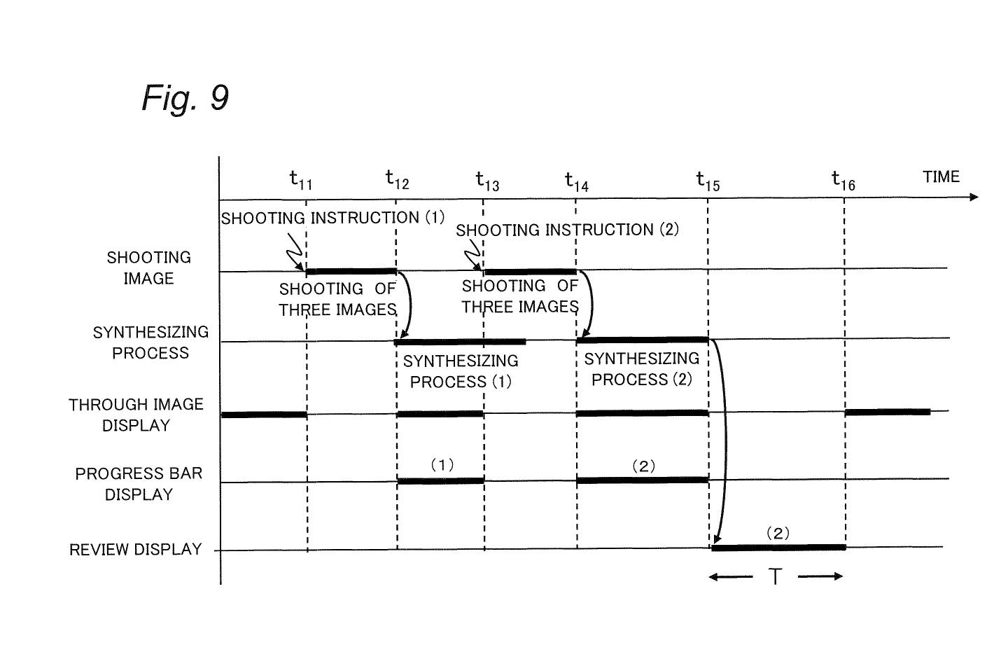

FIG. 9 is a diagram showing timing of the respective processes in time series about the case where the first continuous shooting is performed in the backlight mode and the next continuous shooting is further performed in the backlight mode during the synthesizing process for the first continuous shooting. At time t11, the controller 130 starts the continuous shooting in the backlight mode according to the first shooting instruction in the backlight mode. Accordingly, at time t12, the synthesizing process, the through image display, and the progress bar displaying corresponding to the first shooting instruction are started respectively. Thereafter, when receiving the second shooting instruction at time t13 during the synthesizing process, the controller 130 performs the continuous shooting in the backlight mode in response to the instruction. Due to the start of the second continuous shooting, the through image display and the progress bar display corresponding to the first shooting instruction are stopped. Then, when the second shooting is completed, at time t14, the synthesizing process, the through image display, and the progress bar display corresponding to the second shooting instruction are started respectively. Then, when the synthesizing process corresponding to the second shooting instruction is finished, at time t15, the review display of the synthesized image corresponding to the second shooting instruction is performed for a certain period T.

As described above, the digital camera may be configured to display the review image for the last shot image when the second shooting is performed before the image synthesizing process for the first shooting finishes. As a result, it is possible to prevent the user from being confused by displaying of the review image corresponding to the first shooting just after confirming the review image corresponding to the second shooting, when the shooting of an image is performed twice (i.e., by the situation in which the time series of the shooting and the time series of the review display are reversed). It is needless to say that the digital camera may also be configured to wait for the synthesizing process to finish and then cause the review image in the order of shooting.

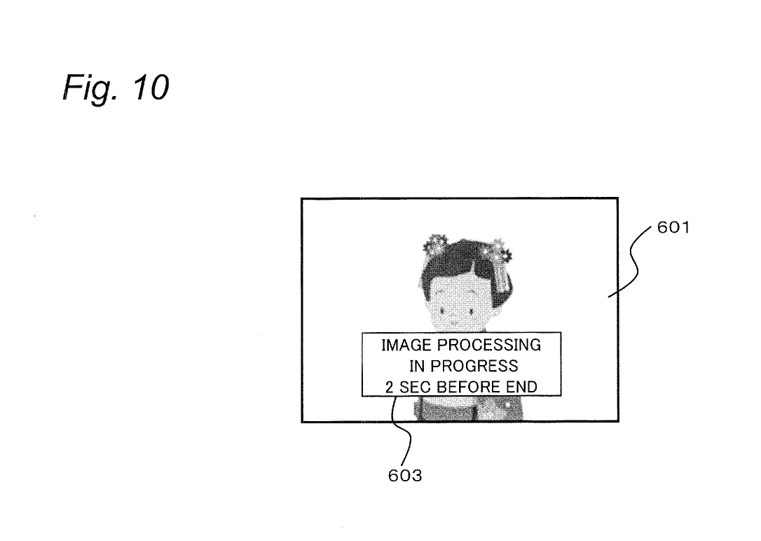

(2) In the above described embodiment, the controller 130 is adapted to superimpose the progress bar on the through image to display on the LCD monitor 123 as information indicating the obtained progress situation. However, the information indicating the progress situation may be displayed in a form other than the progress bar, such as a message describing an estimated remaining time before the review display starts, like “Image processing in progress. Please wait . . . seconds.” as illustrated in FIG. 10. Alternatively, the note may be as simple as “Image processing in progress.” or “Image processing ( . . . % completed)”. Yet alternatively, an icon or the like indicating that the processing is in progress may be displayed. In short, the controller 130 merely needs to display information which can inform the user that the through image is displayed while the captured image data is processed in parallel and that the through image display will switch to the review display in near future.

(3) In the above described embodiment, the synthesizing process of the continuously shot images has been described as an example of the image processing for superimposing the progress bar indicating the progress of the image processing on the through image. However, the image processing to which the above described idea is applied is not limited to the image synthesizing process. That is, during any image processing which requires a relatively long time to be completed, the through image together with the progress bar may be displayed. That is, as in the case of the image processing in the backlight mode, the progress bar display representing the progress of the image processing may be superimposed on the through image during a period from when shooting of one image is started until the image processing of the shot image(s) is completed. With such a display control, the digital camera may provide an effect of enabling the user to take an image by confirming the through image so as not to miss the coming chance for a good shot while perceiving the end timing of the image processing. Such image processing includes, for example, filter processing for blurring the upper part and the lower part in an image to produce a miniature faking effect (diorama effect). It also includes synthesizing processing of continuously shot images in the night view mode.

Further, the controller 130 may perform a control to display the progress bar superimposed on the through image during the image processing only for a particular shooting mode for performing the image processing which takes a relatively long processing time as described above. That is, the controller 130 may switch display/not display of the progress bar superimposed on the through image according to the kind of shooting mode.

(4) In the above described embodiment, the case has been discussed, where while performing the synthesizing process with the image synthesizer 122a on images shot in the backlight mode, the digital camera generates the through image by the display image data generator 122b and displays the through image. However, there is a special mode is possible which creates a special through image by using both of the image synthesizer 122a and the display image data generator 122b and displays the through image. As the special mode, for example, there is a mode which performs alpha blending processing on images previously taken and superimposes the images subjected to the alpha blending on the through image, such as multiple-exposure shooting. Further, a mode is also possible, which applies the diorama effect as described above on the through image. While the digital camera is provided with only one image synthesizer 122a, the image synthesizer 122a cannot perform any processing related to the through image. Therefore, the image synthesizer 122a cannot display the above described special through image, while performing the synthesizing process. Therefore, in that case, the digital camera may be configured to display the progress bar superimposed on a normal through image which is generated only by the display image data generator 122b until the synthesizing process by the image synthesizer 122a finishes. Thereafter, when the synthesizing process finishes, display may be switched from display of the normal through image to display of the special through image which is generated with the image synthesizer 122a. By performing the above described control, a camera with an image processor which does not have a plurality of image synthesizers can provide a user with the through image so that in a special mode, it is possible to prevent the user from missing the chance for a good shot.

The embodiments have been described above as examples of the technology of the present disclosure. For that purpose, the accompanying drawings and the detailed description have been provided.

Consequently, in order to exemplify the above described technology, the constituent elements shown in the attached drawings and described in the detailed description may include not only a constituent element which is necessary to solve the problem but also a constituent element which is not necessary to solve the problem. Accordingly, it should not be instantly understood that the unnecessary constituent element is necessary only because the unnecessary constituent element is shown or described in the accompanying drawings and the detailed description.

Also, since the above described embodiments are for exemplifying the technology of the present disclosure, various changes, substitutions, additions, omissions and the like may be performed on the embodiments without departing from the scope of the claims and the equivalent of the claims.

### INDUSTRIAL APPLICABILITY

The present disclosure can provide an imaging apparatus having a user-friendly interface, therefore, can be applied to electronic appliances which have a through image display function such as, for example, a digital still camera, a digital video camera, a mobile phone, and a smart phone.

What is claimed is:

1. An imaging apparatus comprising:
an imaging unit configured to capture a subject image to generate image data;
an operation unit configured to receive an operation of shooting instruction from a user;
an image processor configured to apply image processing on the image data to generate image data for recording;
a display unit configured to display an image based on the image data generated by the imaging unit; and
a controller configured to control a display of the display unit and operable to:
controls the image processor to apply the image processing on the image data generated by the imaging unit based on the operation of shooting instruction received by the operation unit from the user, and
cause an image based on the image data captured by the imaging unit and information indicating a progress of the image processing to be displayed on the display unit in parallel with the image processing being performed by the image processor, and cause an image based on the image data for recording generated by the image processing to be displayed on the display unit after completion of the image processing by the image processor.

2. The imaging apparatus according to claim 1, wherein the image processing is processing for synthesizing plural pieces of image data.

3. The imaging apparatus according to claim 1, wherein the information indicating the progress of the image processing is information indicating a remaining time before completion of the image processing.

4. The imaging apparatus according to claim 1, wherein the controller performs the control of causing the image based on the image data captured by the imaging unit and information indicating the progress of the image processing to be displayed on the display unit in parallel with the image processing being performed by the image processor, only when the operation unit receives the operation of shooting instruction in a specific shooting mode.

5. The imaging apparatus according to claim 1, wherein, in a case where the operation unit receives a second operation of a second shooting instruction while a first image processing is in progress based on a first operation of a first shooting instruction received by the operation unit, the controller causes image data for recording generated based on the second shooting instruction to be displayed on the display unit without causing image data for recording generated based on the first shooting instruction to be displayed on the display unit.

6. A display method for displaying an image on a display unit of an imaging apparatus, comprising:
applying image processing on image data generated by an imaging unit based on an operation of shooting instruction received by an operation unit of the imaging apparatus;
displaying an image based on the image data captured by the imaging unit and information indicating a progress of the image processing on the display unit in parallel with the image processing; and
displaying an image based on the image data for recording generated by the image processing on the display unit after completion of the image processing.

7. The display method according to claim 6, wherein the image processing is processing for synthesizing plural pieces of image data.

8. The display method according to claim 6, wherein the information indicating the progress of the image processing is information indicating a remaining time before completion of the image processing.

9. The display method according to claim 6, wherein the image based on the image data captured by the imaging unit and information indicating the progress of the image processing is displayed on the display unit in parallel with the image processing only when the operation unit receives the operation of shooting instruction in a specific shooting mode.

10. The display method according to claim 6, wherein, in a case where the operation unit receives a second operation of a second shooting instruction while a first image processing is in progress based on a first operation of a first shooting instruction received by the operation unit, image data for recording generated based on the second shooting instruction is cased to be displayed on the display unit while image data for recording generated based on the first shooting instruction is caused to be displayed on the display unit.

11. The imaging apparatus according to claim 1, wherein the information indicating the progress of the image processing displayed on the display unit is a progress bar which graphically indicates a remaining amount of the image processing.

12. The display method according to claim 6, wherein the information indicating the progress of the image processing displayed on the display unit is a progress bar which graphically indicates a remaining amount of the image processing.
